(19) United States
(12) Patent Application Publication
(10) Pub. No.: US 2010/0123853 A1
(43) Pub. Date: May 20, 2010

(54) LIQUID CRYSTAL DISPLAY PANEL AND APPARATUS COMPRISING THE SAME

(75) Inventors: Yan-fei Hao, Suzhou City (CN); Chun-yu Lee, Hsin-Chu City (TW); Shuang Hou, Suzhou City (CN)

Correspondence Address: AUSTIN RAPP & HARDMAN, 170 South Main Street, Suite 735, SALT LAKE CITY, UT, 84101, US

(73) Assignees: AU Optronics (SUZHOU) Corp., Suzhou Industrial Park (CN); AU Optronics Corp., Hsin-Chu (TW)

(21) Appl. No.: 12/615,084

(22) Filed: Nov. 9, 2009

(30) Foreign Application Priority Data
Nov. 14, 2008 (CN) 200810202773.2

(51) Int. Cl. G02F 1/13357; G02F 1/1335

(52) U.S. Cl. 349/61; 349/96

(57) ABSTRACT

A liquid crystal display panel and an apparatus comprising the same are disclosed. The apparatus comprises the liquid crystal display panel and a backlight module. The backlight module includes a lighting area. The liquid crystal display panel is disposed opposite to the backlight module. The liquid crystal display panel comprises a first substrate facing the backlight module and a first polarizer disposed at the outside of the first substrate. The first polarizer covers the lighting area of the backlight module, but does not exceed or flush with the first substrate.

### CLAIM OF PRIORITY

This application claims priority to Chinese Patent Application No. 200810202773.2 filed on Nov. 14, 2008.

### FIELD OF THE INVENTION

The present invention relates to a liquid crystal display panel and an apparatus comprising the same, and more particularly, to a liquid crystal display panel and an apparatus comprising the same which can improve problems of light leaking and panel fracture.

### BACKGROUND OF THE INVENTION

Liquid crystal displays (LCDs) have been widely applied in electrical products due to the rapid progress of optical and semiconductor technologies. With their advantages of high image quality, compact size, light weight, low driving voltage, low power consumption and various applications, LCDs have been introduced to be utilized in portable computers, mobile phones, personal digital assistants, and color televisions and are becoming the mainstream display apparatus.

Referring to FIG. 7, a cross-section view showing a conventional liquid crystal display is presented herein. Currently, an LCD is composed of a backlight module 910 and a liquid crystal panel 920, and the backlight module 910 is configured to provide the backlight for the liquid crystal panel 920. The liquid crystal panel 920 includes a color filter (CF) substrate 921, a thin film transistor (TFT) array substrate 922, an upper polarizer 923 and a lower polarizer 924. The CF substrate 921 is disposed opposite to TFT substrate 922, wherein a liquid crystal layer (not shown) is disposed between the CF substrate 921 and the TFT substrate 922. The upper polarizer 923 is disposed outside the CF substrate 921, and the lower polarizer 924 is disposed outside the TFT substrate 922.

Referring to FIG. 7 again, it is generally understood that the area of the TFT substrate 922 is larger than the area of the CF substrate 921 so as to form a bonding area 925 on the surrounding of TFT substrate 922. The bonding area 925 is not covered by the CF substrate 921 for mounting driving devices 901, such as a driving chip, a driving IC or a flexible printed circuit (FPC), thereon. At this time, a shading tape 926 with adhesive capability is needed to be adhered on the surrounding of the TFT substrate 922 for preventing the light of the backlight module 910 from leaking to a non-display area of the liquid crystal panel 920.

However, the adhering process of the shading tape 926 needs labor effort and time, thereby increasing manufacturing cost and time. Furthermore, when mounting the driving devices 901 on the bonding area 925 of the TFT substrate 922, the liquid crystal panel 920 is placed on a supporting platform of a bonding tool (not shown) for supporting. At this time, if there is a particle between the supporting platform and the liquid crystal panel 920, it is susceptible to lead to defects such as scratches or a fracture of the liquid crystal panel 920.

### SUMMARY OF THE INVENTION

Therefore, an aspect of the present invention is to provide a liquid crystal display panel and an apparatus comprising the same, thereby enlarging an area of a polarizer to reduce the use of the shading tape for improving the light leaking problem.

Another aspect of the present invention is to provide a liquid crystal display panel and an apparatus comprising the same, thereby preventing that the substrate of the display panel to directly contact with the supporting platform of the bonding tool when mounting an electric device, and thus preventing defects such as scratches or a fracture of the liquid crystal panel.

Another aspect of the present invention is to provide a liquid crystal display panel and an apparatus comprising the same, thereby reducing the peeling problem between a polarizer and a substrate.

Another aspect of the present invention is to provide a liquid crystal display panel and an apparatus comprising the same, thereby preventing that particles from a bonding area or other sources go into a backlight module of the apparatus.

According to an embodiment of the present invention, the liquid crystal display panel comprises a first substrate, a second substrate, a liquid crystal layer and a first polarizer. The first substrate includes a first side face and a bonding area, wherein the bonding area is adjacent to the first side face and configured to mount at least one electric device. The liquid crystal layer is disposed between the first substrate and the second substrate. The first polarizer is disposed at the outside of the first substrate, wherein the first polarizer includes a second side face, and the second side face of the first polarizer and the first side face of the first substrate are positioned at the same side of the liquid crystal display panel, and the second side face is positioned between the first side face and the bonding area, and there is a predetermined distance between the first side face and the second side face.

According to another embodiment of the present invention, the liquid crystal display apparatus comprises a backlight module and a liquid crystal display panel. The backlight module has a lighting area. The liquid crystal display panel is disposed opposite to the backlight module, wherein the liquid crystal display panel comprises a first substrate, a second substrate, a liquid crystal layer and a first polarizer. The first substrate includes a first side face. The liquid crystal layer is disposed between the first substrate and the second substrate. The first polarizer is disposed at the outside of the first substrate, wherein the first polarizer includes a second side face, and the second side face of the first polarizer and the first side face of the first substrate are positioned at the same side of the liquid crystal display panel, and the second side face is positioned between the first side face and the lighting area, and there is a predetermined distance between the first side face and the second side face.

According to another embodiment of the present invention, the liquid crystal display apparatus comprises a backlight module and a liquid crystal display panel. The backlight module has a lighting area. The liquid crystal display panel is disposed opposite to the backlight module, wherein the liquid crystal display panel comprises a first substrate, a second substrate, a liquid crystal layer and a first polarizer. The liquid crystal layer is disposed between the first substrate and the second substrate. The first polarizer is disposed at the outside of the first substrate and at least covers the lighting area of the backlight module, and does not exceed or flushing with the first substrate.

Therefore, with the use of the liquid crystal display panel and the LCD apparatus disclosed in the embodiments of the present invention, the backlight leaking problem can be improved to reduce the use of the shading tape, and the panel of the invention can prevent that the substrate directly contacts with the supporting platform of the bonding tool when mounting the electric device, thereby preventing the defects such as scratches or the fracture of the liquid crystal panel and enhancing product yield and quality. Furthermore, the particles from a bonding area or other sources can be prevented from going into the backlight module of the LCD apparatus.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a cross-section view showing a liquid crystal display panel and a backlight module according to a first embodiment of the present invention;

FIG. 2 is a partially cross-section view showing a liquid crystal display panel according to the first embodiment of the present invention;

FIG. 3A through FIG. 3D show the position relation between a first substrate, a first polarizer and a lighting area according to the first embodiment of the present invention;

FIG. 4 is a cross-section view showing a liquid crystal display panel according to a second embodiment of the present invention;

FIG. 5 is a cross-section view showing an assembly of the liquid crystal display panel and the backlight module according to the second embodiment of the present invention; and

FIG. 6A through FIG. 6D show the position relation between the first substrate, the first polarizer, and a lighting area, according to the second embodiment of the present invention.

FIG. 7 is a cross-section view showing a conventional liquid crystal display.

### DETAILED DESCRIPTION OF THE PREFERRED EMBODIMENT

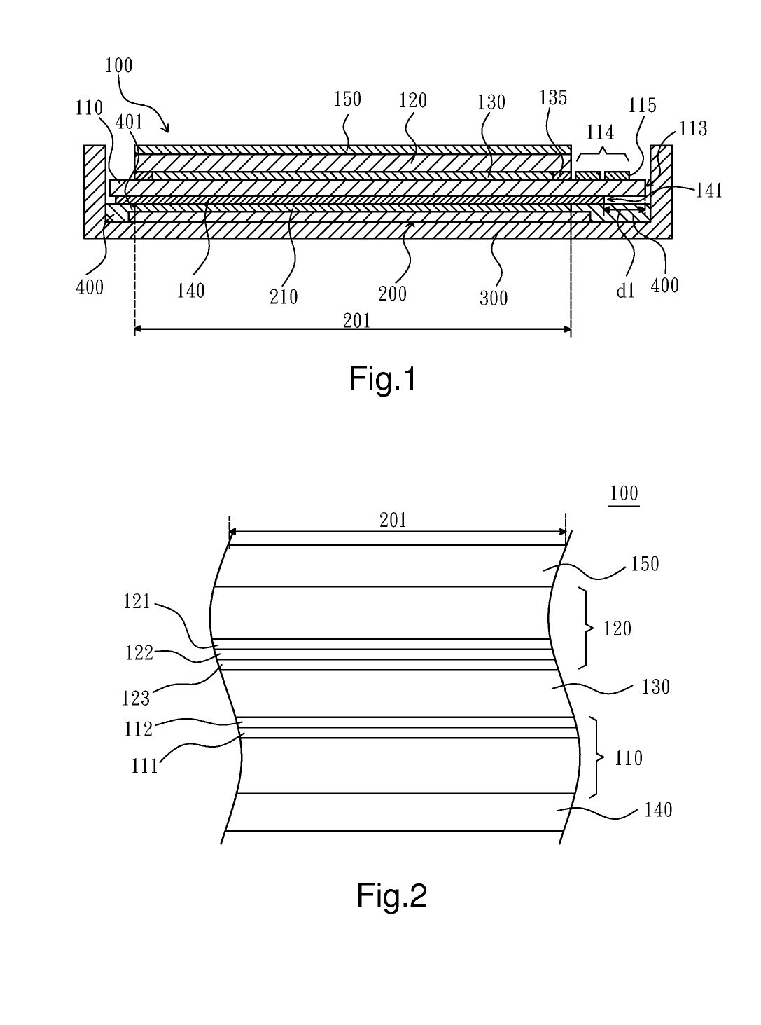

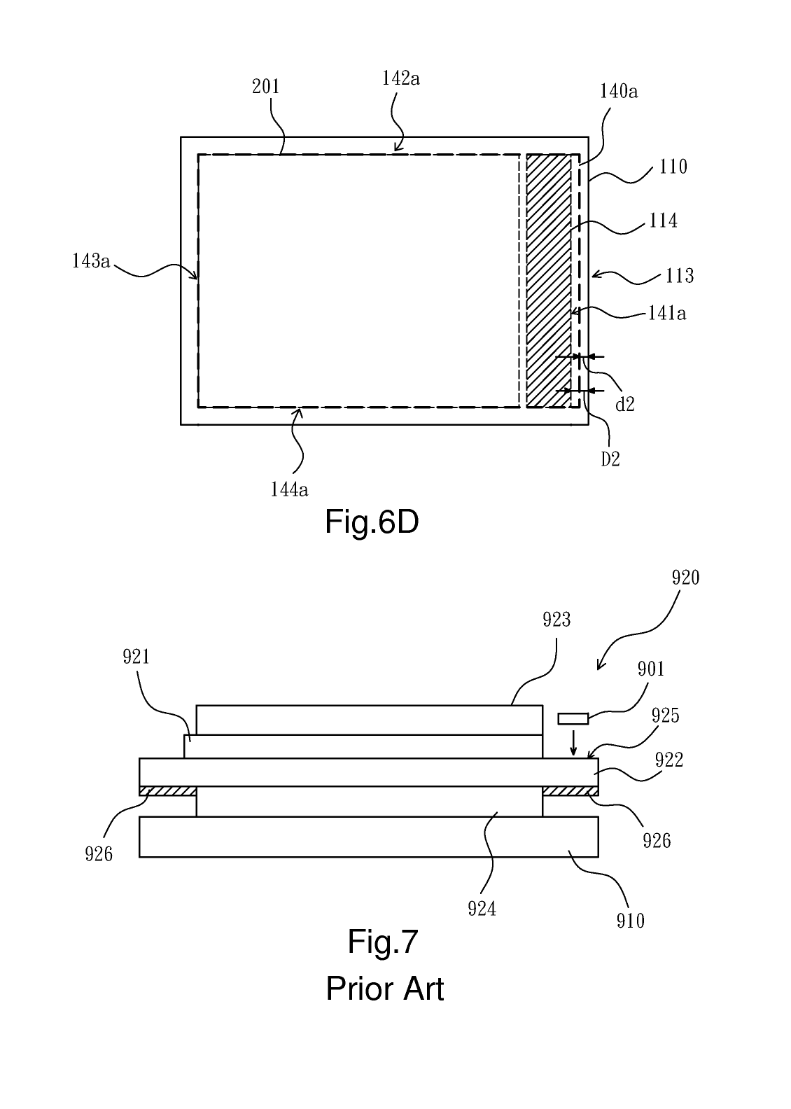

In order to make the illustration of the present invention more explicit and complete, the following description is stated with reference to FIG. 1 through FIG. 7.

Referring to FIG. 1, a cross-section view showing a liquid crystal display panel and a backlight module according to a first embodiment of the present invention is presented herein. The liquid crystal display panel 100 of the present invention is disposed opposite to a backlight module 200, thereby forming an LCD apparatus. The backlight module 200 may be an edge lighting backlight module or a bottom lighting backlight module, wherein the backlight module 200 may include an optical element assembly 210 for backlight efficiency and optical improvement. The optical element assembly 210 may include a diffuser, a light guide, a prism sheet, a turning prism sheet, a brightness enhancement film, a dual brightness enhancement film, a diffused reflective polarizer film or any combination thereof. The backlight module 200 may further include at least one light source (not shown), such as a cold cathode fluorescent lamp (CCFL), a hot cathode fluorescent lamp (HCFL), a light emitting diode (LED), an organic light emitting diode (OLED) or an electro-luminescence (EL) device for providing backlight for the liquid crystal display panel 100.

Referring to FIG. 1 again, in the present embodiment, the LCD apparatus may further comprise a back plate 300 and a frame 400 to carry and assemble the liquid crystal display panel 100 and the backlight module 200. The frame 400 is disposed on the back plate 300 and includes panel supporting portions 401 for supporting the liquid crystal display panel 100. The backlight module 200 further includes a lighting area 201 which is an area thereof not covered by the component that would shield light such as the frame 400, thereby providing backlight for the panel 100.

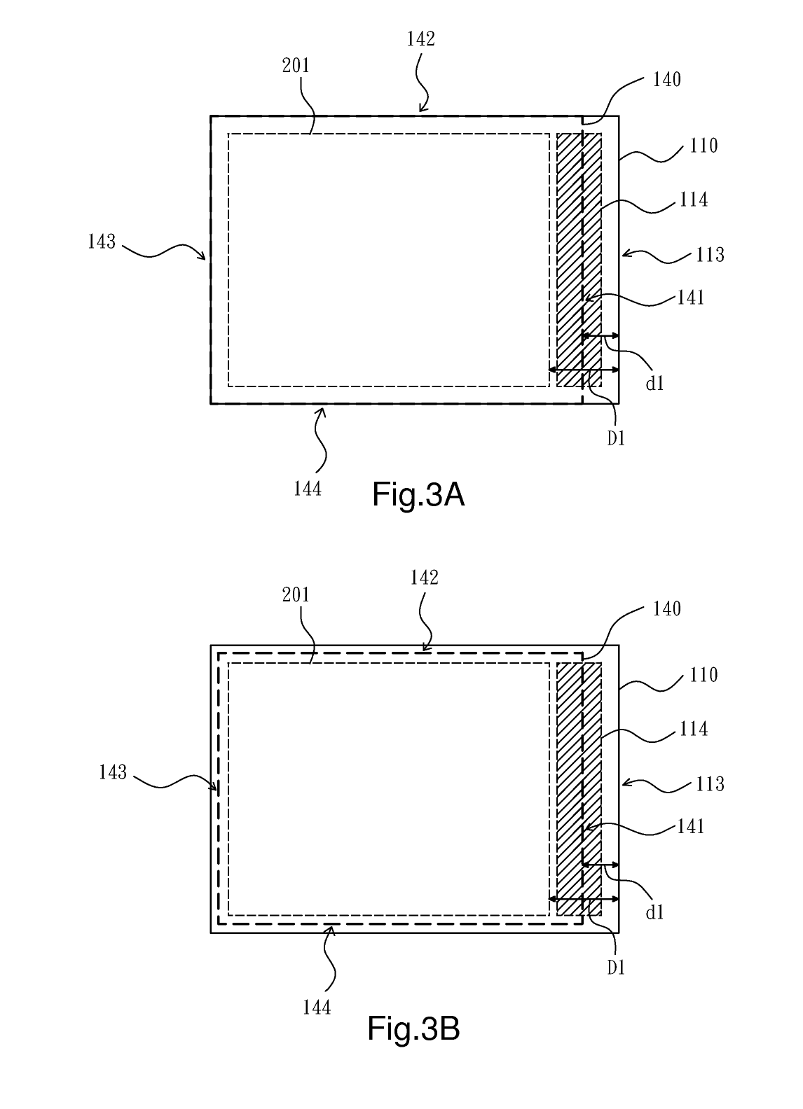

Referring to FIG. 2, a partially cross-section view showing a liquid crystal display panel according to the first embodiment of the present invention is presented herein. The liquid crystal display panel 100 comprises a first substrate 110, a second substrate 120, a liquid crystal layer 130, a first polarizer 140 and a second polarizer 150. The liquid crystal layer 130 is disposed between the first substrate 110 and the second substrate 120 and sealed by a sealant 135. The first polarizer 140 is disposed at the outside of the first substrate 110 opposite to the liquid crystal layer 130. The second polarizer 150 is disposed at the outside of the second substrate 120 opposite to the liquid crystal layer 130.

Referring to FIG. 2 again, the first substrate 110 of the present embodiment may include a plurality of driving devices (not shown), such as TFTs, configured to drive the twist of the liquid crystal molecules (not shown), thereby forming a TFT array substrate. At this time, the first substrate 110 may include a pixel electrode layer 111, a first alignment layer 112, a plurality of gate lines (not shown), a plurality of data lines (not shown), a first side face 113 and a bonding area 114, wherein the gate lines and the data lines are intersected vertically to form a display area (not shown) for display images. The pixel electrode layer 111 and the first alignment layer 112 are disposed at the inside of the first substrate 110 (the side faced to the liquid crystal layer 130) in series. The pixel electrode layer 111 is preferably made of transparent and electrically-conductive material, such as ITO, IZO, AZO, GZO, TCO or ZnO. The bonding area 114 is formed on one side of the display area, adjacent to the first side face 113 and configured to mount at least one electric device 115 thereon, such as a driving chip, a driving IC or an FPC.

It is worth mentioning that the driving devices may be disposed on the second substrate 120 in some embodiments and not limited to be disposed on the first substrate.

Referring to FIG. 2 again, the second substrate 120 may include a black matrix layer 121, a common electrode layer 122 and a second alignment layer 123 disposed on the inside of the second substrate 120 (the side faced to the liquid crystal layer 130). A plurality of color filter layers (not shown) which are made of color resist material and pervious to light may be formed in the black matrix layer 121, and thus the second substrate 120 can be a CF substrate. The material of the black matrix layer 121 may be metal (such as chromium), graphite or polymeric material. The common electrode layer 122 is preferably made of transparent and electrically-conductive material, such as ITO, IZO, AZO, GZO, TCO or ZnO.

It is worth mentioning that the color filter layers and the common electrode layer 122 may be disposed on the first substrate 110, such as color filter on array (COA) in some embodiments and not limited to be disposed on the second substrate 120.

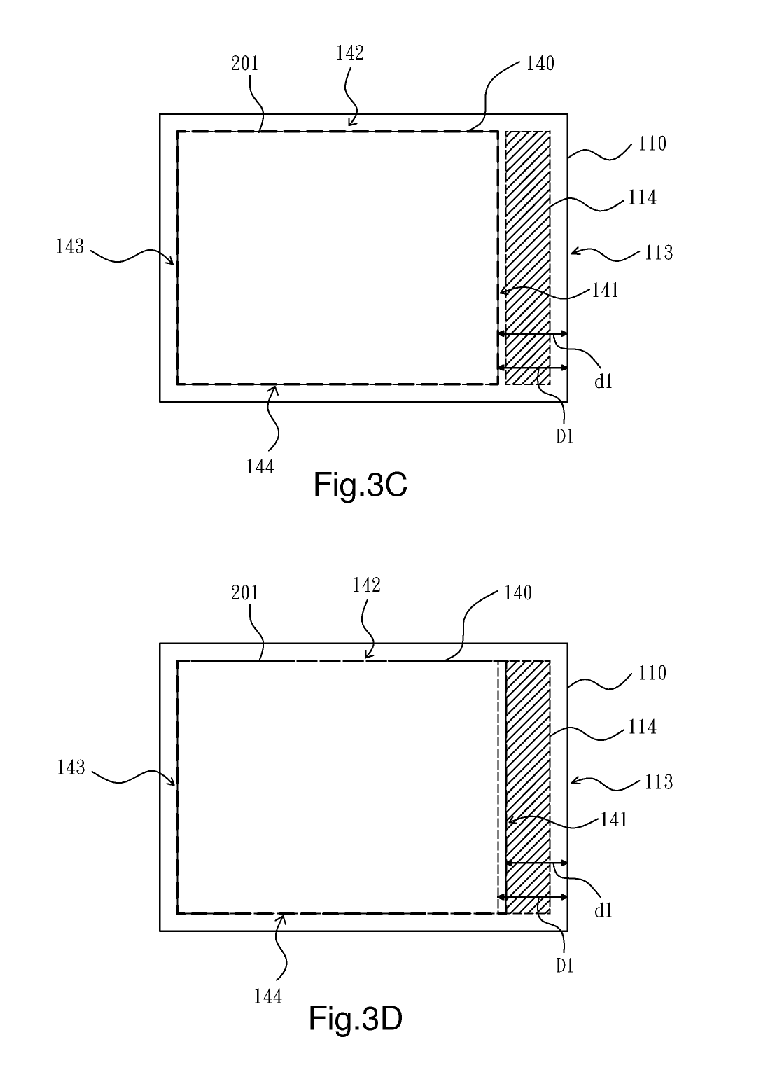

Referring to FIG. 1 and FIG. 3A through FIG. 3D, FIG. 3A through FIG. 3D show the position relation between the first substrate, the first polarizer and a lighting area according to the first embodiment of the present invention. Referring to FIG. 1 and FIG. 3A, when the liquid crystal display panel 100 and the backlight module 200 are assembled, the first polarizer 140 of the liquid crystal display panel 100 at least covers the lighting area 201 of the backlight module 200 but does not exceed or flush with the first substrate 110, i.e. the area of first polarizer 140 is preferably larger or equal to the area of the lighting area 201 and less than the area of the first substrate 110. Therefore, the first polarizer 140 can cover the lighting area 201 of the backlight module 200, thereby improving the light leaking problem of the backlight module 200. Furthermore, particles from the bonding area 114 or other sources can be prevented from going into the backlight module 200. The first polarizer 140 includes a second side face 141 corresponding to the first side face 113 of the first substrate 110. That is, the first side face 113 of the first substrate 110 and the second side face 141 of the first polarizer 140 are positioned at the same side of the liquid crystal display panel 100 adjacent to the bonding area 114, and the second side face 141 is further positioned between the first side face 113 and the lighting area 201, and there is a predetermined distance d1 (such as 2 mm˜3 mm) between the second side face 141 and the first side face 113, i.e. the second side face 141 does not exceed or flush with the first side face 113. A distance D1 between the first side face 113 and the lighting area 201 may be 2 mm˜3 mm. At this time, other side faces 142, 143 and 144 may flush with the edge of the lighting area 201 (referring to FIG. 3C and FIG. 3D), the edge of the first substrate 110 (referring to FIG. 3A), or positioned between the edge of the lighting area 201 and the edge of the first substrate 110 (referring to FIG. 3B). Furthermore, in FIG. 3C, the second side face 141 of the first polarizer 140 may also flush with the edge of the lighting area 201. In FIG. 3D, the second side face 141 of the first polarizer 140 may flush with the edge of the bonding area 114.

It is worth mentioning that there is a predetermined distance between the second side face 141 of the first polarizer 140 and the first side face 113 of the first substrate 110, i.e. the second side face 141 does not flush with the first side face 113. Therefore, the liquid crystal display panel 100 of the present embodiment can reduce the peeling problem between the first polarizer 140 and the first substrate 110, thereby enhancing process and product yield.

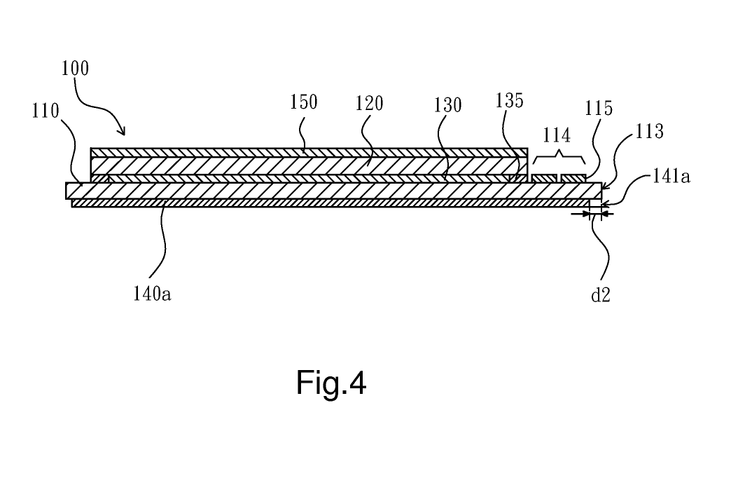

Referring to FIG. 4, a cross-section view showing a liquid crystal display panel according to a second embodiment of the present invention is presented herein. The liquid crystal display panel 100 of the present embodiment comprises the first substrate 110, the second substrate 120, the liquid crystal layer 130, the first polarizer 140a and the second polarizer 150. The first substrate 110 has the first side face 113 and the bonding area 114, and the bonding area 114 is formed adjacent to the first side face 113 configured to mount at least one electric device 115 thereon. The liquid crystal layer 130 is disposed between the first substrate 110 and the second substrate 120 and sealed by dispensing a sealant 135. The first polarizer 140a is disposed at the outside of the first substrate 110 opposite to the liquid crystal layer 130, wherein the first polarizer 140a includes a second side face 141a. The second side face 141a and the first side face 113 are positioned at the same side of the liquid crystal display panel 100, and there is a predetermined distance d2 (such as 100 μm˜200 μm) between the second side face 141a and the first side face 113. The second polarizer 150 is disposed on the outside of the second substrate 120 and opposite to the liquid crystal layer 130.

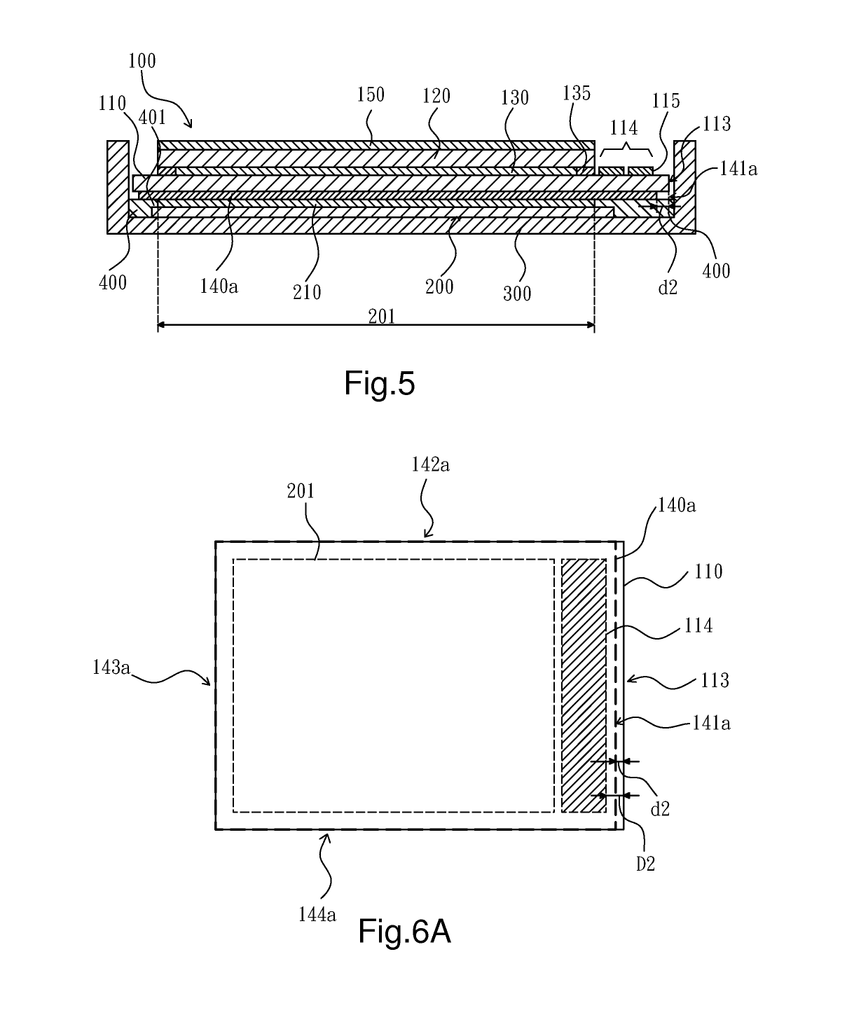

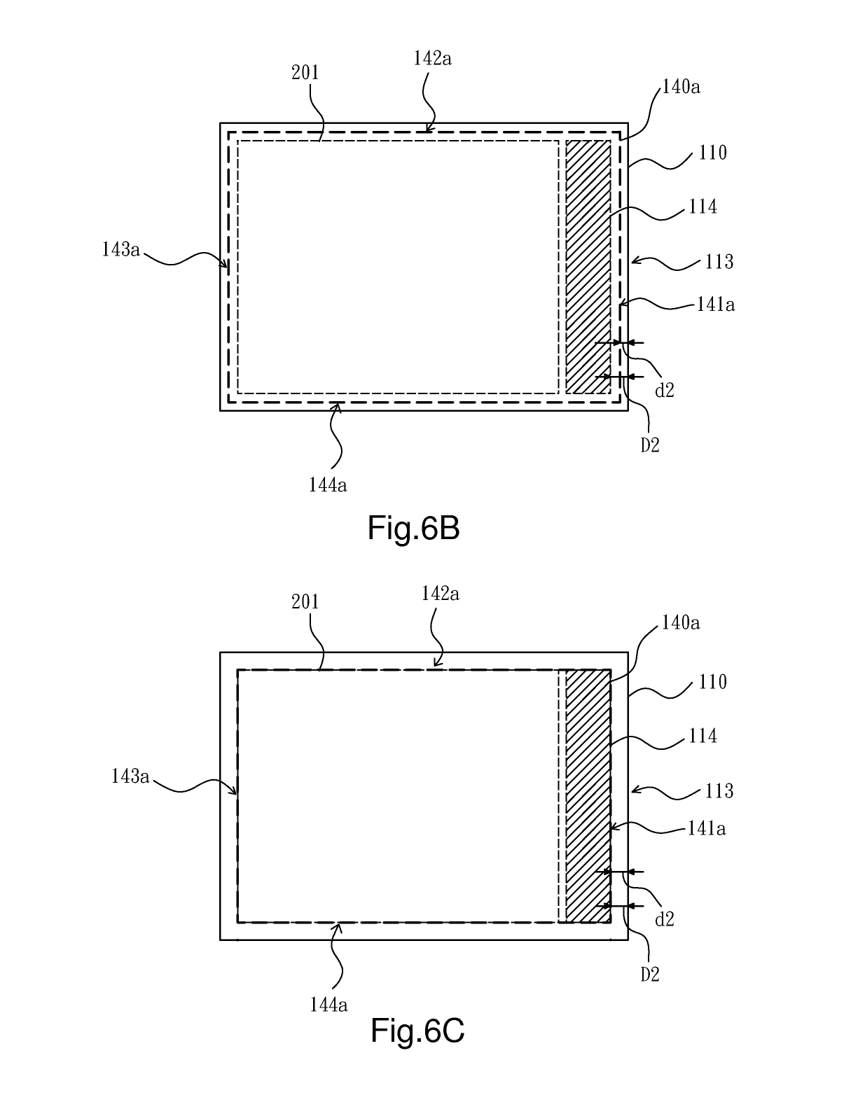

Referring to FIG. 5 and FIG. 6A through FIG. 6D, FIG. 5 is a cross-section view showing an assembly of the liquid crystal display panel and the backlight module according to the second embodiment of the present invention, and FIG. 6A through FIG. 6D show the position relation between the first substrate, the first polarizer and a lighting area according to the second embodiment of the present invention. Referring to FIG. 5 and FIG. 6A again, in the present embodiment, the first polarizer 140a of the liquid crystal display panel 100 preferably further covers the bonding area 114 of the first substrate 110, but does not exceed or flush with the first substrate 110, i.e. the area of the first polarizer 140a is larger than or equal to the total area of the lighter area 201 and the bonding area, and less than the area of the first substrate 110. Therefore, the first polarizer 140a with a lower hardness than that of the first substrate 110 (usually composed of glass) can cover the bonding area 114 of the first substrate 110 to prevent that the backside of the first substrate 110 directly contacts with the supporting platform of the bonding tool (not shown) when mounting the electric device 115, thereby preventing defects such as scratches or a fracture of the liquid crystal panel 100 due to the particles existing between the liquid crystal panel 100 and the supporting platform. At this time, the second side face 141a of the first polarizer 140a is positioned between the first side face 113 and the bonding area 114, and there is another predetermined distance d2 (such as 100 μm˜200 μm) between the second side face 141a and the first side face 113, i.e. the second side face 141a does not exceed or flush with the first side face 113. The predetermined distance D2 between the first side face 113 and the bonding area 114 may be 100 μm˜200 μm. At this time, other side faces 142a, 143a, and 144a of the first polarizer 140a may flush with the edge of the lighting area 201 (referring to FIG. 6C and FIG. 6D), flush with the edge of the first substrate 110 (referring to FIG. 6A), or positioned between the lighting area 201 and the first substrate 110 (referring to FIG. 6B).

Therefore, the liquid crystal display panel and the LCD apparatus of the present invention can enlarge the area of the polarizer to reduce the use of the shading tape and to improve the backlight leaking problem, thereby reducing labor effort, process time and cost. Furthermore, the panel of the invention can prevent that the substrate directly contacts with the supporting platform of the bonding tool when mounting the electric device, thereby preventing the defects such as scratches or the fracture of the liquid crystal panel, enhancing product yield and quality and reducing unnecessary cost lost.

As is understood by a person skilled in the art, the foregoing embodiments of the present invention are strengths of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A liquid crystal display panel, comprising:
a first substrate including a first side face and a bonding area, wherein the bonding area is adjacent to the first side face and is configured to mount at least one electric device;
a second substrate;
a liquid crystal layer disposed between the first substrate and the second substrate; and
a first polarizer disposed at the outside of the first substrate, wherein the first polarizer includes a second side face, and the second side face of the first polarizer and the first side face of the first substrate are positioned at the same side of the liquid crystal display panel, and the second side face is positioned between the first side face and the bonding area, and there is a predetermined distance between the first side face and the second side face.

2. The liquid crystal display panel as claimed in claim 1, wherein the distance between the first side face and the bonding area is between 100 μm and 200 μm.

3. A liquid crystal display apparatus, comprising:
a backlight module having a lighting area; and
a liquid crystal display panel disposed opposite to the backlight module, wherein the liquid crystal display panel comprises:
a first substrate including a first side face;
a second substrate;
a liquid crystal layer disposed between the first substrate and the second substrate; and
a first polarizer disposed at the outside of the first substrate, wherein the first polarizer includes a second side face, and the second side face of the first polarizer and the first side face of the first substrate are positioned at the same side of the liquid crystal display panel, and the second side face is positioned between the first side face and the lighting area, and there is a predetermined distance between the first side face and the second side face.

4. The liquid crystal display apparatus as claimed in claim 3, wherein the distance between the first side face and the lighting area is between 2 mm and 3 mm.

5. The liquid crystal display apparatus as claimed in claim 3, wherein the area of the first polarizer is lager than the area of the lighting area.

6. The liquid crystal display apparatus as claimed in claim 3, wherein the first substrate further includes at least one bonding area configured to mount at least one electric device and adjacent to the first side face, and the second side face is positioned between the first side face and the bonding area.

7. The liquid crystal display apparatus as claimed in claim 6, wherein the distance between the first side face and the bonding area is between 100 μm and 200 μm.

8. The liquid crystal display apparatus as claimed in claim 7, wherein the area of the first polarizer is lager than or equal to the total area of the lighting area and the bonding area.

9. A liquid crystal display apparatus, comprising:
a backlight module having a lighting area; and
a liquid crystal display panel disposed opposite to the backlight module, wherein the liquid crystal display panel comprises:
a first substrate;
a second substrate;
a liquid crystal layer disposed between the first substrate and the second substrate; and
a first polarizer disposed at the outside of the first substrate and at least covering the lighting area of the backlight module and not exceeding or flushing with the first substrate.

10. The liquid crystal display apparatus as claimed in claim 9, wherein the first substrate further includes at least one bonding area configured to mount at least one electric device, and the first polarizer further covers the bonding area.
